(19) United States
(12) Patent Application Publication
(10) Pub. No.: US 2025/0253924 A1
(43) Pub. Date: Aug. 7, 2025

(54) TRANSMISSION CONFIGURATION INDICATOR (TCI) STATE REPORTING DOWNLINK RECEIVE BEAMS PREDICTED BY AN AI-BASED BEAM MANAGEMENT MODEL

(71) Applicant: Apple Inc., Cupertino, CA (US)

(72) Inventors: Huaning NIU, San Jose, CA (US); Wei ZENG, Saratoga, CA (US); Weidong YANG, San Diego, CA (US); Dawei ZHANG, Saratoga, CA (US); Ankit BHAMRI, Bad Nauheim (DE); Haitong SUN, Cupertino, CA (US); Hong HE, San Jose, CA (US)

(73) Assignee: Apple Inc., Cupertino, CA (US)

(21) Appl. No.: 18/982,072

(22) Filed: Dec. 16, 2024

Related U.S. Application Data
(60) Provisional application No. 63/549,413, filed on Feb. 2, 2024.

(51) Int. Cl. H04B 7/06; H04B 17/318; H04W 24/02

(52) U.S. Cl. CPC H04B 7/06968; H04B 17/328; H04W 24/02

(57) ABSTRACT

A user equipment can receive a transmission configuration indicator (TCI) state including an indication of a reference signal and a quasi co-location (QCL) type to be applied to the reference signal, where the reference signal can be determined based on a predicted beam in a set A of beams that is predicted by an AI model based on a set of reference signal measurements performed using a set B of measurement beams by the UE. The UE can determine, based on the reference signal and the QCL type included in the received TCI state, a receive beam for communications between the UE and the wireless network.

### CROSS-REFERENCE TO RELATED APPLICATIONS

This application claims the benefit of U.S. Provisional Patent Application No. 63/549,413, filed on Feb. 2, 2024, the contents of which are incorporated herein by reference in its entirety.

### BACKGROUND

### Field

The described aspects generally relate to wireless communication systems, including transmission configuration indicator (TCI) state indicating downlink receive beams based on one or more beams predicted by an Artificial Intelligence (AI)-based beam management model.

### Related Art

A wireless communication system can include a fifth generation (5G) system, a New Radio (NR) system, a long term evolution (LTE) system, a combination thereof, or some other wireless systems. In addition, a wireless communication system can support a wide range of use cases such as enhanced mobile broad band (eMBB), massive machine type communications (mMTC), ultra-reliable and low-latency communications (URLLC), and enhanced vehicle to anything communications (eV2X). Artificial Intelligence (AI) has gained significant attention across various fields in recent years. In wireless communication, AI can be used to facilitate various physical layer (PHY) procedures, such as AI-based beam management.

### SUMMARY

Some aspects of this disclosure relate to apparatuses and methods for implementing techniques for transmission configuration indicator (TCI) state indicating downlink receive beams based on beams predicted by an Artificial Intelligence (AI)-based beam management model. The implemented techniques can be applicable to many wireless systems, e.g., a wireless communication system based on 3rd Generation Partnership Project (3GPP) release 15 (Rel-15), release 16 (Rel-16), release 17 (Rel-17), or others.

Some aspects of this disclosure relate to a user equipment (UE). The UE can include a transceiver and a processor communicatively coupled to the transceiver. The transceiver can enable wireless communication with a base station in a wireless network. The processor can receive a transmission configuration indicator (TCI) state including an indication of a reference signal and a quasi co-location (QCL) type to be applied to the reference signal, where the reference signal can be determined based on a predicted beam in a set A of beams that is predicted by an AI model based on a set of reference signal measurements performed using a set B of measurement beams by the UE. In addition, the processor can determine, based on the reference signal and the QCL type included in the received TCI state, a receive beam based on the predicted beam in the set A of beams for communications between the UE and the wireless network.

Some aspects of this disclosure relate to a method performed by a UE. The method can include receiving a TCI state comprising an indication of a reference signal and a QCL type to be applied to the reference signal, where the reference signal is determined based on a predicted beam in a set A of beams that is predicted by an AI model based on a set of reference signal measurements performed using a set B of measurement beams by the UE. Afterwards, the method can include determining, based on the reference signal and the QCL type included in the received TCI state, a receive beam based on the predicted beam in the set A of beams for communications between the UE and the wireless network.

In some embodiments, the set B of measurement beams can be a subset of the set A of beams. In some other embodiments, the set B of measurement beams can be disjoint from the set A of beams. In some embodiments, the AI model can be operated by the base station or within the wireless network. In some other embodiments, the AI model can be operated by the UE. In some embodiments, a set B of measurement beams can be simply referred to as a set B of beams.

In some embodiments, the reference signal indicated by the TCI state can be measured using a measurement beam in the set B of measurement beams. In some embodiments, the reference signal can be a Synchronization Signal (SS) Block (SSB) or a Channel Status Information Reference Signal (CSI-RS) having a strongest layer one reference signal received power (L1-RSRP) measurement among the set of reference signal measurements performed by the set B of measurement beams. In some embodiments, the measurement beam can be adjacent to the predicted beam in a beam pattern formed by the set B of measurement beams and the set A of beams. In some embodiments, the reference signal can be a first reference signal, and the TCI state further includes a second reference signal measured by a second measurement beam in the set B of measurement beams, and the receive beam can be determined based on the first reference signal and the second reference signal.

In some embodiments, the reference signal indicated by the TCI state can be associated with the predicted beam in the set A of beams, and the receive beam can be determined based on measurement beams used in data collection for training the AI model. In some embodiments, the AI model can be operated by the UE, and the predicted beam in the set A of beams is predicted by the UE based on the AI model. In addition, the UE can further report the predicted beam in the set A of beams to the wireless network. In some embodiments, the TCI state can include an indication of the predicted beam in the set A that is predicted by the UE.

In some embodiments, the received TCI state is a first TCI state for a first time instance, the determined receive beam is a first receive beam determined for the first time instance, and the method can further include receiving a second TCI state comprising an indication of a second reference signal, where the second reference signal is determined based on a second predicted beam in the set A of beams that is predicted for a second time instance by the AI model based on the set of reference signal measurements performed by the set B of measurement beams by the UE. Afterwards, the method can further include determining, based on the second reference signal indicated by the second TCI state, a second receive beam for communications between the UE and the wireless network for the second time instance.

In some embodiments, the set of reference signal measurements performed by the set B of measurement beams is a first set of reference signal measurements performed at a first time instance. The method can further include reporting to the wireless network the first set of reference signal measurements performed at the first time instance; and reporting to the wireless network a second set of reference signal measurements performed at a second time instance, wherein the predicted beam in the set A of beams is predicted by the AI model based on the first set of reference signal measurements and the second set of reference signal measurements.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIGS. 1A-1D illustrate wireless systems including a base station and a user equipment (UE) for transmission configuration indicator (TCI) state indicating downlink receive beams based on beams predicted by an Artificial Intelligence (AI)-based beam model, according to some aspects of the disclosure.

FIG. 2 illustrates a block diagram of a UE, according to some aspects of the disclosure.

FIG. 3 illustrates an example process performed by a UE for TCI state indicating downlink receive beams based on beams predicted by an AI-based beam model, according to some aspects of the disclosure.

FIGS. 4A-4C illustrate details of example processes for TCI state indicating downlink receive beams based on beams predicted by an AI-based beam model, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In a fifth generation (5G) system, a New Radio (NR) system, or other wireless systems, massive multiple input, multiple output (MIMO) technology has gained more popularity. With the increasing number of antenna arrays in a wireless system or network, beam management has become more important. Beam management may include a series of procedures such as beam sweeping, beam measurements, beam determination, beam reporting, and beam failure recovery.

An artificial Intelligence (AI)-based beam management model, alternatively referred to as beam management (BM), has been studied. In some embodiments, two main use cases for an AI-based beam model are discussed, where BM-Case 1 focuses on spatial-domain downlink (DL) beam prediction based on measurement results from a set of measurement beams, while BM-Case 2 is temporal DL beam prediction by using historical measurement results from a set of measurement beams. In some embodiments, spatial-domain downlink beam prediction leverages measurement outcomes from a designated set of downlink beams, denoted as “set B” or “Set B”, to predict the best beam within another set of downlink beams, termed “set A” or “Set A”, at an instance in time. In some embodiments, the predicted best beam within the set A of beams may be simply referred to as a predicted beam, which can be used to determine a receive (Rx) beam. Time-domain downlink beam prediction harnesses historical measurement results derived from ‘set B’ to anticipate the best beam in ‘set A’ for one or more future time instances. In some embodiments, the set A may be referred to as a first set while the set B may be referred to as a second set. In particular, how to perform beam reporting or indication from a wireless network for a beam predicted or selected from the set A of beams, which may or may not be in set B of beams may be a problem to be solved. In some embodiments, the beam reporting of the predicted beam may include a beam identifier, a beam angle information, and other beam information.

Some aspects of this disclosure provide mechanisms for a UE in a wireless network or system. A method performed by a UE can include receiving a transmission configuration indicator (TCI) state comprising an indication of a reference signal and a quasi co-location (QCL) type to be applied to the reference signal, where the reference signal is determined based on a predicted beam in a Set A of beams that is predicted by an AI model based on a set of reference signal measurements performed using a Set B of measurement beams by the UE. Afterwards, the method can include determining, based on the reference signal and the QCL type included in the received TCI state, a receive (Rx) beam selected by the UE corresponding to the predicted beam from the Set A of beams for communications between the UE and the wireless network. In some embodiments, the Set A of beams and the Set B of beams both include transmission beams of a base station, such as a gNB beam for transmission. The UE can receive a beam signal using a different codebook compared to that of the base station. Accordingly, the UE can select the Rx beam corresponding to the transmission beam in set B of the beams for the base station. In some embodiments, the QCL type may be QCL type D having spatial receiver parameters such as a dominant angle of arrival, and/or an average angle of arrival at the UE. The Set B of measurement beams may simply be referred to as the Set B of beams.

In some embodiments, at a fixed location, the UE can derive the Rx beam based on QCL type D relationship between different reference signals (RS). For example, a Synchronization Signal (SS) Block (SSB) or a Channel Status Information Reference Signal (CSI-RS) can be QCLed, the UE can assume the same UE beam for receiving/transmitting QCLed transmissions. A TCI state can be used to indicate the QCL source reference signal as specified in TS 38.214, such as section 5.1.5. In legacy beam management, a TCI state can indicate the source RS for the signal/channel receiving. Accordingly, the UE can use the Rx beam which was used for the measurement for the source RS. In AI based beam management, the relationship is not clear, as the beam predicted in the Set A of beams may or may not be adjacent to the measurement beam in the Set B of beams.

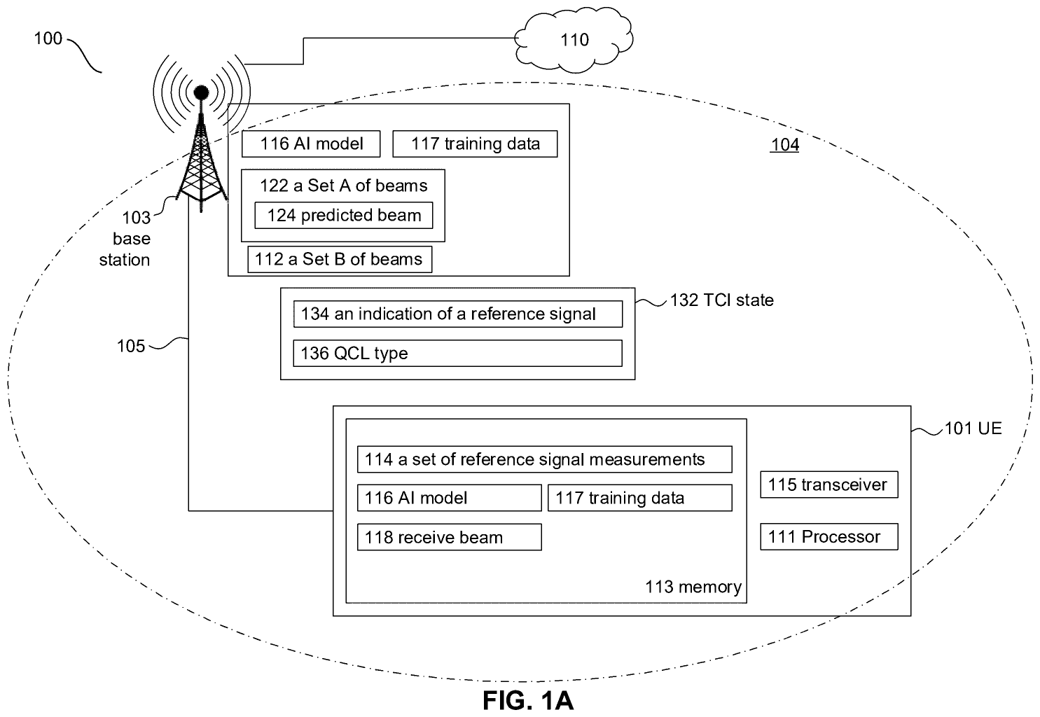

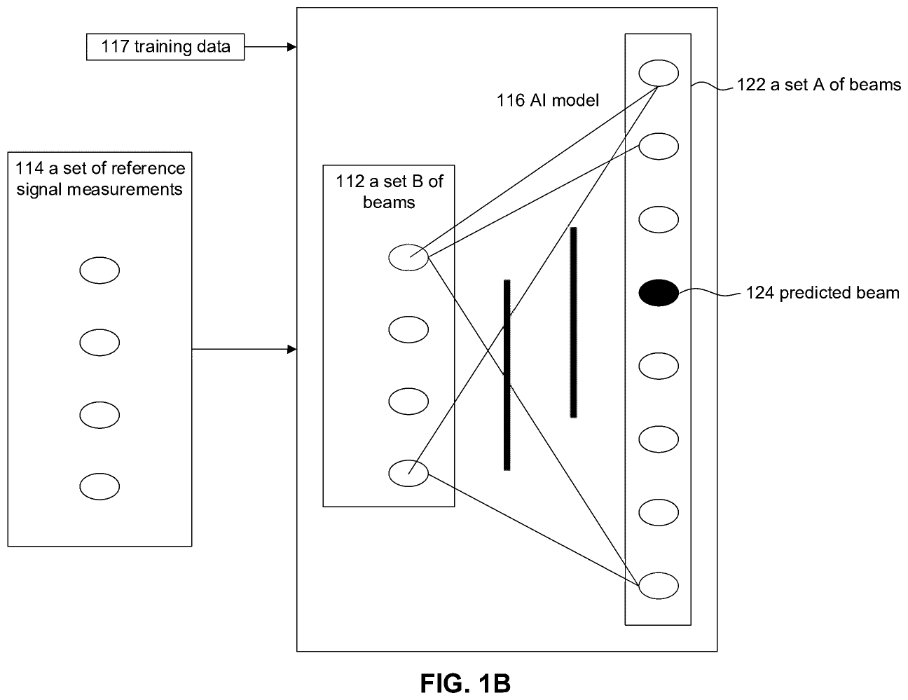

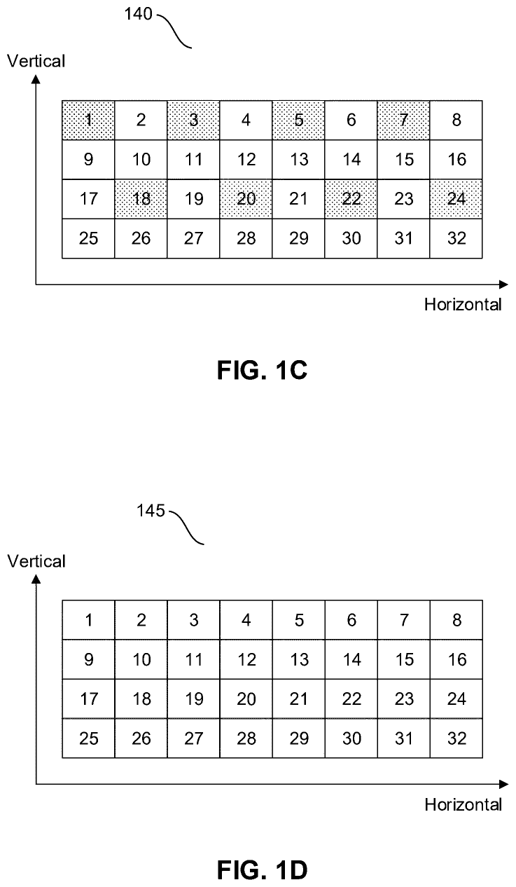

FIGS. 1A-1D illustrate a wireless system 100 including a base station and a UE for TCI state indicating downlink beams based on beams predicted by an AI-based beam model, according to some aspects of the disclosure. Wireless system 100 is provided for the purpose of illustration only and does not limit the disclosed aspects. A wireless system can be referred to as a wireless network, a wireless communication system, or some other names known to a person having ordinary skill in the art.

As shown in FIG. 1A, wireless system 100 can include, but is not limited to, a UE 101 and a base station 103 coupled to a core network 110. There can be other network entities, e.g., network controller, and a relay station, not shown. Base station 103 can wirelessly communicate with UE 101 in a cell 104 through a channel 105.

In some examples, wireless system 100 can be a NR system, a LTE system, a 5G system, or some other wireless system. In addition, wireless system 100 can support a wide range of use cases such as enhanced mobile broad band (eMBB), massive machine type communications (mMTC), ultra-reliable and low-latency communications (URLLC), enhanced vehicle to anything communications (eV2X), or other wireless communication cases.

According to some aspects, UE 101 can be stationary or mobile. UE 101 can be a cellular phone (e.g., a smart phone), a personal digital assistant (PDA), a wireless modem, a wireless communication device, a handheld device, a laptop, a desktop, a cordless phone, a wireless local loop station, a tablet, a camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

According to some aspects, base station 103 can be a fixed station or a mobile station. Base station 103 can also be called other names, such as a base transceiver system (BTS), an access point (AP), a transmission/reception point (TRP), an evolved NodeB (eNB), a next generation node B (gNB), a 5G node B (NB), or some other equivalent terminology.

According to some aspects, base station 103 can provide wireless coverage for cell 104. In some embodiments, cell 104 can be a macro cell, a pico cell, a femto cell, and/or another type of cell. For comparison, a macro cell can cover a relatively large geographic area, e.g., several kilometers in radius, a femto cell can cover a relatively small geographic area, e.g., a home, while a pico cell covers an area smaller than the area covered by a macro cell but larger than the area covered by a femto cell.

In some embodiments, UE 101 can include a processor 111, a memory 113, and a transceiver 115. Transceiver 115 can enable wireless communication with base station 103 in a wireless network or system, e.g., wireless system 100. Processor 111 can receive, via transceiver 115, a transmission configuration indicator (TCI) state 132 including an indication of a reference signal 134 and a QCL type 136 to be applied to reference signal 134, where reference signal 134 can be determined based on a predicted beam 124 in a Set A of beams 122 that is predicted by an AI model 116 based on a set of reference signal measurements 114 performed using a Set B of beams 112 by UE 101. In addition, processor 111 can determine, based on reference signal 134 and QCL type 136 included in TCI state 132, a receive beam 118 based on predicted beam 124 in the Set A of beams 122 for communications between UE 101 and the wireless network, e.g., base station 103. For example, base station 103 can send downlink (DL) beam 1 from the set B of beams for measurement by UE 101. Accordingly, UE 101 can measure DL beam 1 using UE Rx beam 1,2,3,4, and determine that Rx beam 3 is the best Rx beam for DL beam 1 of set B of beams of base station 103. For future transmissions using predicted beam 2 from set A, and QCLed with beam 1 of set B, UE 101 knows Rx beam 3 has the best Rx performance for beam 1 of set B, and therefore Rx beam 3 should be chosen as the receive beam 118. Accordingly, receive beam 118 is determined as a receive beam having the best performance among the receive beams of the UE for the downlink beam selected within the set B of beams, where the downlink beam of the set B of beams is selected based on predicted beam 124, the QCL type 136, and reference signal 134.

In some embodiments, AI model 116 can be operated by UE 101. In some other embodiments, AI model 116 can be operated by the wireless network, such as base station 103 or core network 110. In some embodiments, as shown in FIG. 1B, AI model 116 can be trained by a set of training data 117. AI model 116 can receive the set of reference signal measurements 114 performed using the Set B of measurement beams 112, and determine predicted beam 124 in the Set A of beams 122. In some embodiments, AI model 116 can include multiple layers, where the Set B of measurement beams 112 can be represented by the input layer, and the Set A of beams 122 can be represented by the output layer. AI model 116 can be based on one or more machine learning models, such as supervised machine learning model. In some embodiments, the set of training data 117 can be collected and based on the set of reference signal measurements 114. In some embodiments, the set of training data 117 can be accumulated over time for multiple set of reference signal measurements 114 performed over multiple time instances.

In some embodiments, the Set B of beams 112 can be included as a subset of the Set A of beams 122. As shown in FIG. 1C, the Set B of beams 112 can include 8 beams, with beam index 1, 3, 5, 7, 18, 20, 22, and 24; while the Set A of beams 122 can include 32 beams having index from 1 to 32. The 32 beams of the Set A of beams 122, which includes the beams of the Set B of beams 112, form a two dimensional beam pattern 140 as shown in FIG. 1C, where the horizontal direction and vertical direction are representative of the physical dimensions of the corresponding beams. In some embodiments, as shown in FIG. 1D, the Set B of beams 112 can include 8 beams, with beam index 1, 2, 7, 8, 9, 10, 15, and 16, which are wider beams in comparison with other beams in the Set A of beams 122 that includes 32 beams having index from 1 to 32. The 32 beams of the Set A of beams 122, which includes the beams of the Set B of beams 112, form a two dimensional beam pattern 145 as shown in FIG. 1D. In some other embodiments, the Set B of beams 112 can be disjoint from the Set A of beams 122. For example, as shown in FIG. 1C, the Set B of beams 112 can include 8 beams, with beam index 1, 3, 5, 7, 18, 20, 22, and 24, while the Set A of beams 122 can include 24 beams with a beam index from 1 to 32, but different from the beams in the Set B of beams 112.

In some embodiments, reference signal 134 indicated by TCI state 132 can be measured using a measurement beam in the Set B of measurement beams 112. In some embodiments, reference signal 134 can be a Synchronization Signal (SS) Block (SSB) or a Channel Status Information Reference Signal (CSI-RS) having a strongest layer one reference signal received power (L1-RSRP) measurement among the set of reference signal measurements 114 performed by the Set B of measurement beams 112. In some embodiments, the measurement beam can be adjacent to predicted beam 124 in a beam pattern formed by the Set B of beams and the Set A of beams, such as beam pattern 140 in FIG. 1B or beam pattern 145 shown in FIG. 1C. In some embodiments, reference signal 134 can be a first reference signal, and TCI state 132 further includes a second reference signal measured by a second measurement beam in the Set B of measurement beams 112, and receive beam 118 can be determined based on the first reference signal and the second reference signal. In some embodiments, the Set B of measurement beams 112 can be a subset of the Set A of beams 122. Selecting the receive beam 118 based on the predicted beam selected from the Set A of beams 122 can provide a better receive beam in comparison to limiting the receive beam corresponding to the Set B of beams 112.

In some embodiments, reference signal 134 included in TCI state 132 can be associated with predicted beam 124 in the Set A of beams 122, and receive beam 118 can be determined based on measurement beams used in data collection of training data 117 for training AI model 116. In some embodiments, AI model 116 can be operated on UE 101, and predicted beam 124 in the Set A of beams 122 can be predicted by UE 101 based on AI model 116. In addition, UE 101 can further report predicted beam 124 in the Set A of beams 122 to the wireless network, e.g., base station 103. In some embodiments, TCI state 132 can include an indication of predicted beam 124 in the Set A of beams 122 that is predicted by UE 101.

In some embodiments, TCI state 132 can be a first TCI state for a first time instance, receive beam 118 can be a first receive beam determined for the first time instance. UE 101 can further receive a second TCI state including a second reference signal, where the second reference signal can be determined based on a second predicted beam in the Set A of beams 122 that is predicted for a second time instance by AI model 116 based on the set of reference signal measurements 114 performed using the Set B of measurement beams 112 of UE 101. Afterwards, UE 101 can determine, based on the second reference signal included in the second TCI state, a second receive beam for communications between UE 101 and base station 103 for the second time instance.

In some embodiments, the set of reference signal measurements 114 performed using the Set B of measurement beams 112 can be a first set of reference signal measurements performed at a first time instance. UE 101 can report to base station 103 or the wireless network the first set of reference signal measurements performed at the first time instance. In addition, UE 101 can report to base station 103 a second set of reference signal measurements performed at a second time instance. Accordingly, predicted beam 124 in the Set A of beams 122 can be predicted by AI model 116 based on the first set of reference signal measurements and the second set of reference signal measurements.

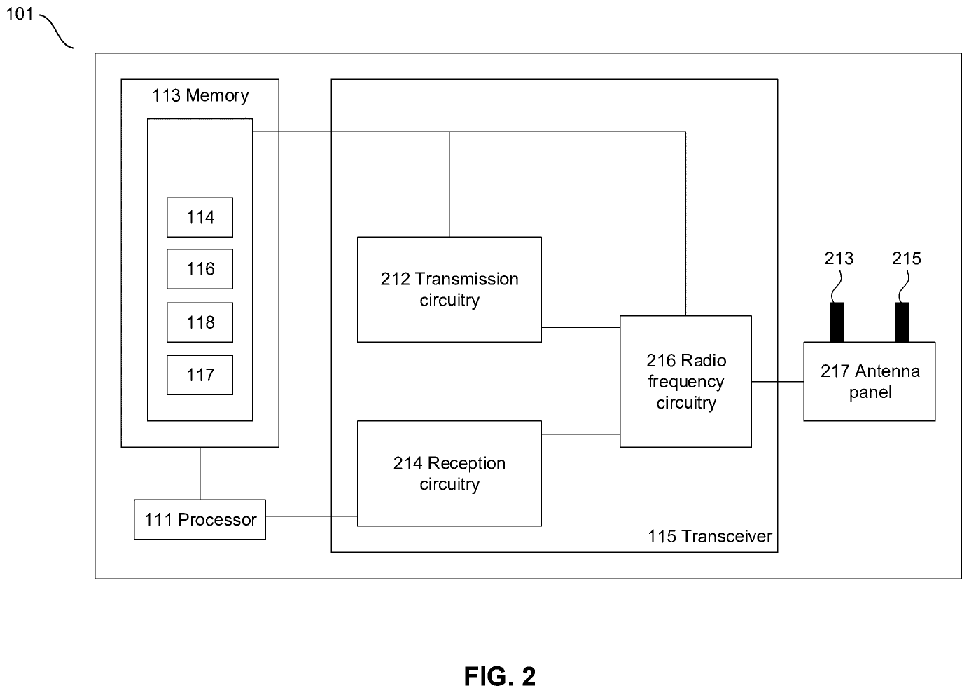

According to some aspects, UE 101 can be implemented according to a block diagram as illustrated in FIG. 2. Referring to FIG. 2, UE 101 can have antenna panel 217 including one or more antenna elements to form various transmission beams, e.g., transmission beam 213 and transmission beam 215, coupled to transceiver 115 and controlled by processor 111. Transceiver 115 and antenna panel 217 (using transmission beam 213 and transmission beam 215) can be configured to enable wireless communication in a wireless network. In detail, transceiver 115 can include radio frequency (RF) circuitry 216, transmission circuitry 212, and reception circuitry 214. RF circuitry 216 can include multiple parallel RF chains for one or more of transmit or receive functions, each connected to one or more antenna elements of the antenna panel. In addition, processor 111 can be communicatively coupled to memory 113, which are further coupled to transceiver 115.

Various data can be stored in memory 201. In some examples, memory 201 can store the Set B of beams 112, the set of reference signal measurements 114, AI model 116, receiving beam 118, and training data 117, as described in FIG. 1A.

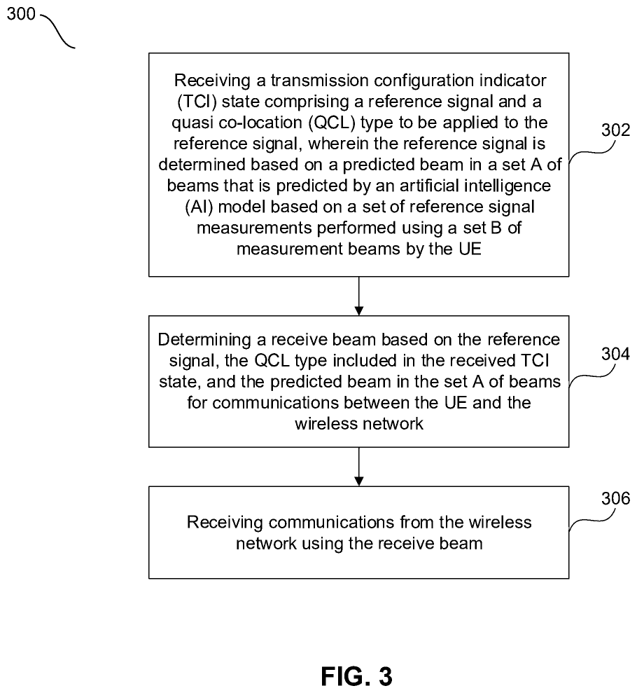

In some embodiments, memory 201 can include instructions, that when executed by processor 111 perform operations described herein, e.g., operations described in process 300 shown in FIG. 3 for UE 101, namely, operations for TCI state reporting downlink receive beams predicted by an AI-based beam model described herein in process 300. Alternatively, processor 111 can be “hard-coded” for UE 101 to perform operations for TCI state reporting downlink receive beams predicted by an AI-based beam model described herein in process 300.

FIG. 3 illustrates an example process 300 performed by UE 101 for TCI state indicating downlink receive beams based on a predicted beam by an AI-based beam model, according to some aspects of the disclosure.

In some embodiments, at 302, processor 111 can be configured to receive TCI state 132 including an indication of reference signal 134 and QCL type 136 to be applied to reference signal 134. In some embodiments, reference signal 134 can be determined based on predicted beam 124 in the Set A of beams 122 that is predicted by AI model 116 based on the set of reference signal measurements 114 performed using the Set B of measurement beams 112 by the UE 101. For example, reference signal 134 can be selected as the strongest layer one reference signal received power (L1-RSRP) measurement among the set of reference signal measurements performed using the set B of measurement beams 112. For example, UE Rx beam can be acquired based on previous measurements for the Set B of beams.

At 304, processor 111 can determine receive beam 118 based on reference signal 134, QCL type 136, and predicted beam 124 in the Set A of beams 122 for communications between UE 101 and base station 103. For example, downlink (DL) beam 1 from the set B is sent for measurement by UE 101. Accordingly, UE 101 can measure using UE Rx beam 1,2,3,4, and Rx beam 3 is the best Rx beam for Tx beam 1 of set B of beams of base station 103. For future transmissions using predicted beam 2 from set A, and QCLed with beam 1 of set B, UE 101 can determine Rx beam 3 has the best Rx performance for beam 1 of set B, and therefore Rx beam 3 should be chosen as the receive beam 118. In some embodiments, receive beam 118 can be selected as the measurement beam for reference signal 134, and reference signal 134 can be a reference signal having the strongest layer one reference signal received power (L1-RSRP) measurement among the set of reference signal measurements performed using the set B of measurement beams. In some embodiments, receive beam 118 can be selected based on an adjacent beam to the measurement beam for reference signal 134 indicated by TCI state 132. In some embodiments, there can be multiple TCI states indicating multiple reference signals, and receive beam 118 can be determined based on multiple reference signals indicated by multiple TCI states based on adjacency of the measurement beams for the multiple reference signals. In some embodiments, receive beam 118 can be directly equal to predicted beam 124 as indicated by reference signal 134. There can be other ways to determine receive beam 118 known by one having the ordinary skills in the art.

At 306, processor 111 can further receive communications from the base station using receive beam 118.

In some embodiments, TCI state 132 can include reference signal 134 and a QCL type D. An example TCI state 132 including a periodic SSB or CSI-RS is shown below:

| dl-OrJointTCI-StateToAddModList SEQUENCE (SIZE | |
|---|---|
| (1..maxNrofTCI-States)) OF TCI-State | |
| TCI-State ::= SEQUENCE { | |
| tci-StateId | TCI-StateId |
| qcl-Type1 | QCL-Info, |
| qcl-Type2 | QCL-Info OPTIONAL, |
| ......... } | |
| QCL-Info ::= SEQUENCE { | |
| cell | ServCellIndex OPTIONAL |
| bwp-Id | BWP-Id OPTIONAL |
| referenceSignal CHOICE { | |
| csi-rs | NZP-CSI-RS-ResourceId |
| ssb | SSB-Index |
| csi-rs | NZP-CSI-RS-ResourceId |
| ssb | SSB-Index |

```
    },
    qcl-Type ENUMERATED {typeA, typeB, typeC, typeD}
```

In some embodiments, AI model 116 may reside at the network side, e.g., base station 103. UE 101 can report back to base station 103 the set of reference signal measurements 114, which can be a set of L1-RSRP measured by beams in the Set B of beams 112. The wireless network or base station 103 can run AI model 116 to determine the predicted beam 124 selected from the Set A of beams 122, as shown in FIG. 1B. In some embodiments, predicted beam 124 can be a finer beam for aperiodic (ap)-CSI-RS transmission or data/control transmission/reception. In some embodiments, base station 103 or the wireless network may not know how UE 101 determines Rx beam to measure the Set A and Set B in data collection for training.

In some embodiments, base station 103 can indicate reference signal 134 together with QCL type 136 for the Set B of beams. In some embodiments, reference signal 134 can be a SSB or periodic CSI-RS having a strongest L1-RSRP measurement among the set of reference signal measurements 114 performed using the Set B of measurement beams 112.

In some embodiments, reference signal 134 may be measured by a beam that is adjacent to the predicted beam 124 in a beam pattern formed by the Set A of beams regardless its L1-RSRP. For example, as shown in FIG. 1C, when beam 28 in Set A of beams is the predicted beam 124, reference signal 134 can be the source reference signal for beam 20, which is adjacent to beam 28 in beam pattern 140. Reference signal 134 can be a SSB, a periodic (p)-CSI-RS or semi-persistent (sp)-CSI-RS. Accordingly, reference signal 134 is associated with beam 20 in the Set B of beams 112, where beam 20 is adjacent to beam 28 that is the predicted beam of the Set A of beams. After receiving reference signal 134 associated with beam 20 in the Set B of beams 112, UE 101 can determine that the receive beam corresponds to beam 28 adjacent to beam 20, which is the same as the predicted beam of the Set A of beams. In some other embodiments, UE 101 may determine the receive beam to be one corresponding to another adjacent beam, such as beam 19 or beam 21, which can be different from beam 28 that is the predicted beam.

In some embodiments, more than one reference signals with similar L1-RSRP measurement can be included in TCI state 132 besides reference signal 134, which can report predicted beam 124 of the Set A of beams 122. Accordingly, UE 101 can derive the Rx beam based on the beams measured for each reference signal included in TCI state 132. For example, as shown in FIG. 1C, when predicted beam 124 is determined to be beam 12 by AI model 116, three potential QCL source reference signals can be included in TCI state 132, where the three reference signals can correspond to the reference signal measurements performed using beam index 3, 5, and 20 of the Set B of beams 112. Beams with beam index 3, 5, and 20 are all adjacent to beam 12 in the Set A of beams. Accordingly, UE 101 can determine the receive beam 118 to be the beam corresponding to beam 12, which is the same as the predicted beam 124. In some embodiments, UE 101 can determine the receive beam 118 that is different from a beam corresponding to predict beam 124, which can cause some performance loss.

In some embodiments, base station 103 can send TCI state 132 including reference signal 134 that corresponds to a beam in the Set A of beams 122. Hence, reference signal 134 is not a measured reference signal using the Set B of beams 112 and reported by UE 101. Accordingly, UE 101 may not determine receive beam 118 explicitly based solely on reference signal 134 included in TCI state 132. In this case, UE 101 can determine receive beam 118 based on training data 117 that is used for training AI model 116. In some embodiments, during data collection for training data 117, base station 103 can configure the start time of data collection for training data 117. Base station 103 can configure the start time by a RRC message that includes an identifier indicating a relationship between the Set B of beams 112 and the Set A of beams 122. In some embodiments, receive beams of UE 101 used to collect training data 117 can have global coordinates to identify the individual beams. In some embodiments, UE 101 can rotate during inferencing, and can implement operations to find the global coordinate for receive beam index during movements such as rotation. In some embodiments, base station 103 can perform the P3 procedure for beam management for additional Rx beam training before data transmission.

In some embodiments, AI model 116 can be located in UE 101 and can determine predicted beam 124 of the Set A of beams 122. For UE side model, UE 101 can report predicted beam 124 of the Set A beams 122 back to base station, where the report can include the beam index and/or corresponding L1-RSRP of the predicted beam. In some embodiments, UE 101 can also send the reference signal measured in the Set B of beams back to base station 103. Base station 103 may follow the recommendation from UE 101 for the predict beam 124. If base station 103 follows the recommendation or indication of predicted beam 124 from UE 101, TCI state 132 can include the reference signal 134 corresponding with the source reference signal for the predicted beam 124. In some embodiments, base station 103 can discard the predicted beam 124 reported by UE 101. Instead, base station 103 can indicate that the DL beam is any beam of the Set A of beams 122. Afterwards, UE 101 can choose the proper receive beam based on the indication from base station 103. In some embodiments, base station 103 can indicate a source reference signal corresponding to predicated beam 124 of the Set A of beams 122, which be used in training data 117.

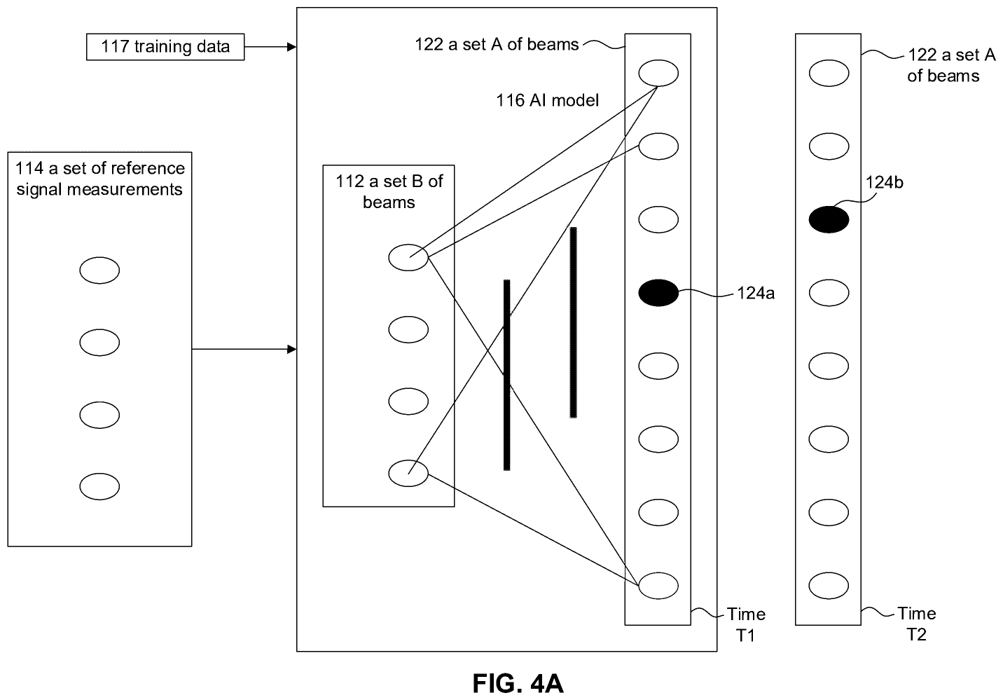

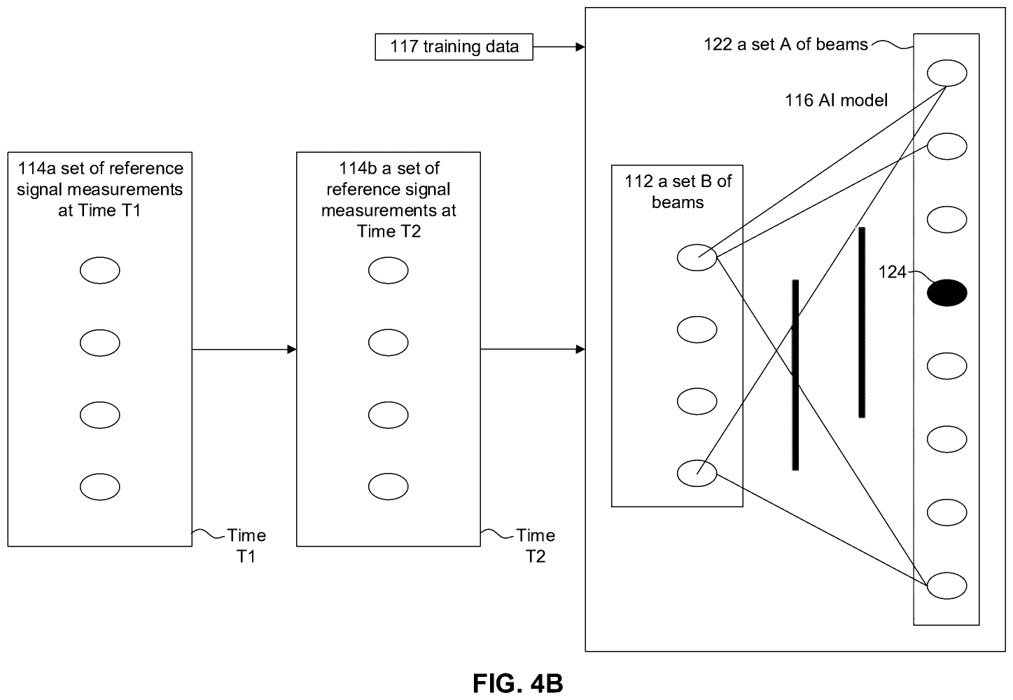

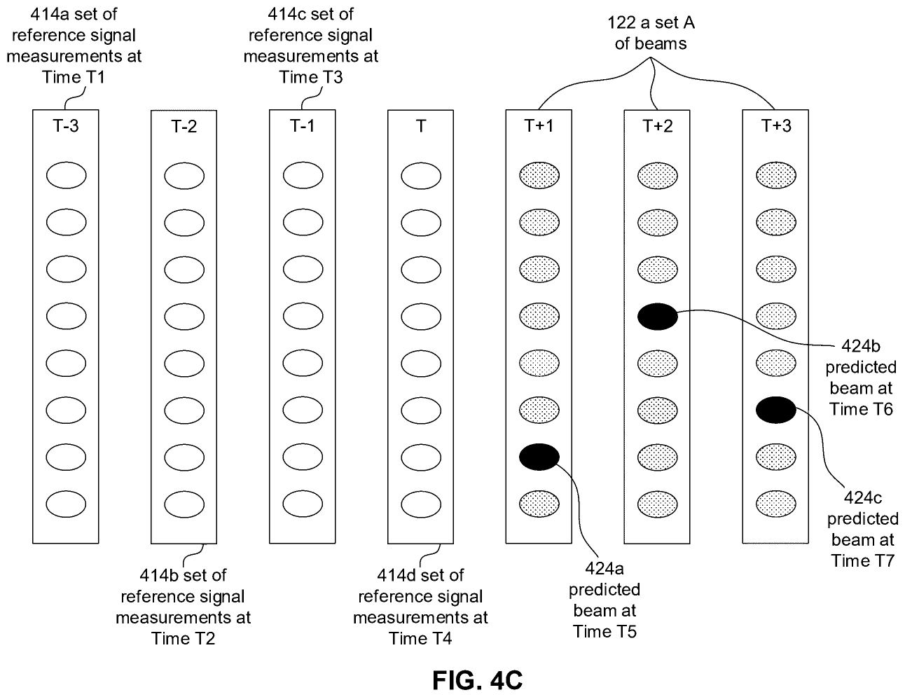

In some embodiments, TCI state 132 can be a first TCI state for a first time instance T1, receive beam 118 can be a first receive beam determined for the first time instance that is related to a first predicted beam 124a of the Set A of beams 122 as shown in FIG. 4A. In addition, UE. 101 can further receive a second TCI state including a second reference signal, where the second reference signal can be determined based on a second predicted beam 124b in the Set A of beams 122, as shown in FIG. 4A. In some embodiments, the second predicted beam 124b can be predicted for a second time instance T2 by AI model 116 based on the set of reference signal measurements 114 performed by the Set B of measurement beams 112 of UE 101. Afterwards, UE 101 can determine, based on the second reference signal included in the second TCI state, a second receive beam for communications between UE 101 and base station 103 for the second time instance T2.

In some embodiments, as shown in FIG. 4B, the set of reference signal measurements 114a performed by the Set B of beams 112 can be a first set of reference signal measurements performed at a first time instance T1. UE 101 can report to base station 103 or the wireless network the first set of reference signal measurements 114a performed at the first time instance T1. In addition, UE 101 can report to base station 103 a second set of reference signal measurements 114b performed at a second time instance T2. Accordingly, predicted beam 124 in the Set A of beams 122 can be predicted by AI model 116 based on the first set of reference signal measurements 114a and the second set of reference signal measurements 114b.

In some embodiments, as shown in FIG. 4C, there can be multiple sets of reference signal measurements, such as a set of reference signal measurement 414a performed at time instance T1, a set of reference signal measurement 414b performed at time instance T2, a set of reference signal measurement 414c performed at time instance T3, and a set of reference signal measurement 414d performed at time instance T4, which are all performed by the Set B of beams 112. AI model 116 can be used to determine predicted beam 424a for time instance T5, predicted beam 424b for time instance T6, and predicted beam 424c for time instance T7.

In some embodiments, the Set B of beams 112 and the Set A of beams 122 can be of the same size. In some embodiments, the Set B of beams 112 and the Set A of beams 122 can be the same set. In addition, AI model 116 can reside on the network side, e.g., on base station 103. In some embodiments, base station 103 can send TCI state 132 to indicate reference signal 134 to indicate the predicted beam 124 of the Set A of beams 122. In some embodiments, base station 103 can send TCI state 132 to indicate reference signal 134 as the strongest reference signal among the set of reference signal measurements 114 performed using the Set B of beams 112.

In some embodiments, the Set B of beams 112 can be smaller than the Set A of beams 122. In addition, AI model 116 can reside on the network side, e.g., on base station 103. In some embodiments, base station 103 can send TCI state 132 including reference signal 134 to indicate the predicted beam 124 of the Set A of beams 122.

In some embodiments, the Set B of beams 112 and the Set A of beams 122 can be of the same size. In some embodiments, the Set B of beams 112 and the Set A of beams 122 can be the same set. In addition, AI model 116 can reside on UE 101. In some embodiments, UE 101 can report to base station 103 predicted beam 124 of the Set A of beams 122, where predicted beam 124 is a recommended beam at a future time. Base station 103 can use the same recommended beam or predicted beam 124 to be included in TCI state 132. In some embodiments, base station 103 can decide not to indicate the reference signal associated with predicted beam 124. Instead, base station 103 can directly indicate the downlink beam as predicted beam 124 based on the recommendation of UE 101. Accordingly, it is up to the wireless network to follow the UE recommended beam index. If the wireless network follows the UE's recommendation, TCI state 132 can include corresponding QCL source RS to be reported to UE 101. In addition, UE 101 can implement operations to determine the proper receive beam 118 based on the received reference signal included in TCI state 132.

In some embodiments, the Set B of beams 112 can be smaller than the Set A of beams 122. In addition, AI model 116 can reside on UE 101. In some embodiments, base station 103 can send TCI state 132 including reference signal 134 to indicate the predicted beam 124 of the Set A of beams 122.

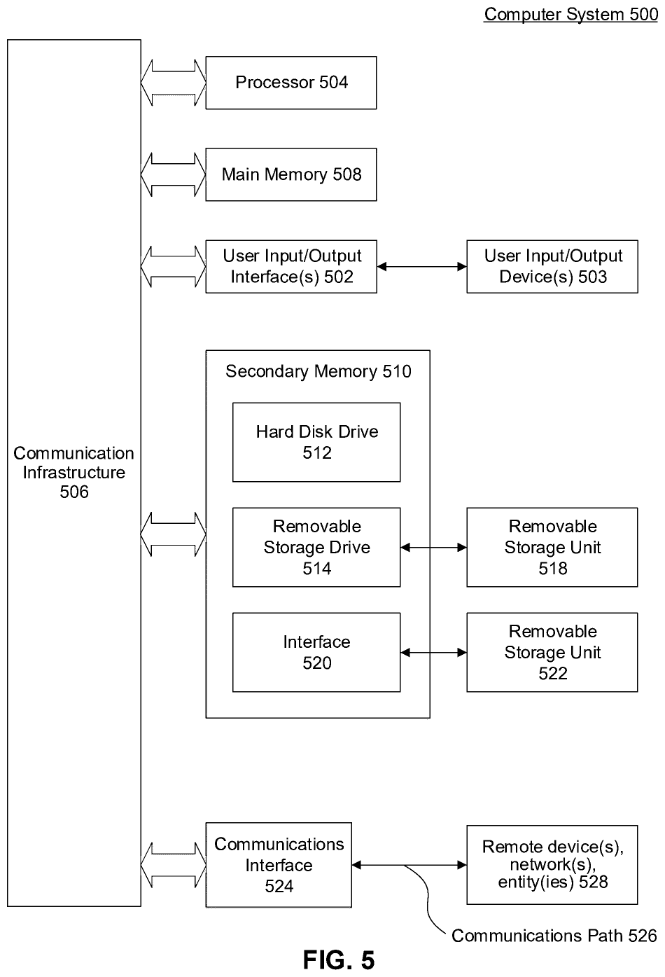

Various aspects can be implemented, for example, using one or more computer systems, such as computer system 500 shown in FIG. 5. Computer system 500 can be any computer capable of performing the functions described herein such as base station 103, UE 101, as shown in FIGS. 1A-1D and FIG. 2, for operations described for processor 111 or process 300. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., base station 103, UE 101, as shown in FIGS. 1A-1D and FIG. 2. In some examples, the operations include those operations illustrated and described in for processor 111 or process 300 as shown in FIGS. 2-3.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method of performing wireless communication by a user equipment (UE) in a wireless network, comprising:
receiving a transmission configuration indicator (TCI) state comprising an indication of a reference signal and a quasi co-location (QCL) type to be applied to the reference signal, wherein the reference signal is determined based on a predicted beam in a set A of beams that is predicted by an artificial intelligence (AI) model based on a set of reference signal measurements performed using a set B of measurement beams by the UE; and
determining a receive beam based on the reference signal, the QCL type included in the received TCI state, and the predicted beam in the set A of beams for communications between the UE and the wireless network.

2. The method of claim 1, wherein the reference signal indicated by the TCI state is measured using a measurement beam in the set B of measurement beams.

3. The method of claim 2, wherein the reference signal is selected as a Synchronization Signal (SS) Block (SSB) or a Channel Status Information Reference Signal (CSI-RS) having a strongest layer one reference signal received power (L1-RSRP) measurement among the set of reference signal measurements performed using the set B of measurement beams.

4. The method of claim 2, wherein the measurement beam is adjacent to the predicted beam in a beam pattern formed by the set B of measurement beams and the set A of beams.

5. The method of claim 2, wherein the reference signal is a first reference signal, and the TCI state further includes an indication of a second reference signal measured by a second measurement beam in the set B of measurement beams, and the receive beam is determined based on the predicted beam in the set A of beams based on the first reference signal and the second reference signal.

6. The method of claim 1, wherein the set B of measurement beams is a subset of the set A of beams.

7. The method of claim 1, wherein the set B of measurement beams is disjoint from the set A of beams.

8. The method of claim 1, wherein the AI model is operated by the wireless network, and the predicted beam in the set A of beams is predicted by the wireless network based on the AI model.

9. The method of claim 1, wherein the reference signal indicated by the TCI state is associated with the predicted beam in the set A of beams, and the determining the receive beam comprises determining the receive beam based on measurement beams used in data collection for training the AI model.

10. The method of claim 9, wherein the AI model is operated by the UE, the predicted beam in the set A of beams is predicted by the UE based on the AI model, and the method further comprises:
reporting the predicted beam in the set A of beams to the wireless network.

11. The method of claim 10, wherein the TCI state includes an indication of the predicted beam in the set A that is predicted by the UE.

12. The method of claim 1, wherein the TCI state is a first TCI state for a first time instance, the determining the receive beam is a first receive beam determined for the first time instance, and the method further comprising:
receiving a second TCI state comprising an indication of a second reference signal, wherein the second reference signal is determined based on a second predicted beam in the set A of beams that is predicted for a second time instance by the AI model based on the set of reference signal measurements performed by the Set B of measurement beams by the UE; and
determining a second receive beam based on the second reference signal included in the second TCI state and the second predicted beam in the set A of beams for communications between the UE and the wireless network for the second time instance.

13. The method of claim 1, wherein the set of reference signal measurements performed using the set B of measurement beams is a first set of reference signal measurements performed at a first time instance, and the method further comprising:
reporting to the wireless network the first set of reference signal measurements performed at the first time instance; and
reporting to the wireless network a second set of reference signal measurements performed at a second time instance, wherein the predicted beam in the set A of beams is predicted by the AI model based on the first set of reference signal measurements and the second set of reference signal measurements.

14. A user equipment (UE), comprising:
a transceiver configured to enable wireless communication with a base station in a wireless network; and
a processor communicatively coupled to the transceiver and configured to:
receive from the base station a transmission configuration indicator (TCI) state comprising an indication of a reference signal and a quasi co-location (QCL) type to be applied to the reference signal, wherein the reference signal is determined based on a predicted beam in a set A of beams that is predicted by an artificial intelligence (AI) model based on a set of reference signal measurements performed using a Set B of measurement beams by the UE; and
determine a receive beam based on the reference signal, the QCL type included in the received TCI state, and the predicted beam in the set A of beams for communications between the UE and the base station.

15. The UE of claim 14, wherein the reference signal indicated by the TCI state is measured using a measurement beam in the set B of measurement beams.

16. The UE of claim 15, wherein the reference signal is selected as a Synchronization Signal (SS) Block (SSB) or a Channel Status Information Reference Signal (CSI-RS) having a strongest layer one reference signal received power (L1-RSRP) measurement among the set of reference signal measurements performed using the set B of measurement beams.

17. The UE of claim 15, wherein the measurement beam is adjacent to the predicted beam in a beam pattern formed by the set B of measurement beams and the set A of beams.

18. The UE of claim 14, wherein the reference signal indicated by the TCI state is associated with the predicted beam in the set A of beams, and the determining the receive beam comprises determining the receive beam based on measurement beams used in data collection for training the AI model.

19. A non-transitory computer-readable medium storing instructions that, when executed by a processor of a user equipment (UE), cause the UE to perform operations, the operations comprising:
receiving a transmission configuration indicator (TCI) state comprising an indication of a reference signal and a quasi co-location (QCL) type to be applied to the reference signal, wherein the reference signal is determined based on a predicted beam in a set A of beams that is predicted by an artificial intelligence (AI) model based on a set of reference signal measurements performed using a Set B of measurement beams by the UE; and
determining a receive beam based on the reference signal, the QCL type included in the received TCI state, and the predicted beam in the set A of beams for communications between the UE and the base station.

20. The non-transitory computer-readable medium of claim 19, wherein the reference signal indicated by the TCI state is measured using a measurement beam in the set B of measurement beams.
